(19) United States
(12) Patent Application Publication
(10) Pub. No.: US 2012/0257950 A1
(43) Pub. Date: Oct. 11, 2012

(54) PRODUCTION SYSTEM

(75) Inventors: Thomas Mattern, Rieden (DE); Herbert Guggemos, Untrasried (DE); Markus Zolitsch, Haldenwang (DE)

(73) Assignee: LIEBHERR-VERZAHNTECHNIK GMBH, Kempten (DE)

(21) Appl. No.: 13/443,323

(22) Filed: Apr. 10, 2012

(30) Foreign Application Priority Data
Apr. 11, 2011 (DE) 10 2011 016 713.7

(51) Int. Cl. B23Q 7/10

(52) U.S. Cl. 414/223.01

(57) ABSTRACT

The present disclosure relates to a production system having at least one machine tool and at least one pallet handling system for the automatic loading of at least one machine tool. The at least one pallet handling system has a storage unit associated with at least one machine tool and having one or more shelf modules. The storage unit additionally includes at least one rotatable storage tower.

### CROSS REFERENCE TO RELATED APPLICATION

This application claims priority to German Patent Application No. 10 2011 016 713.7, entitled “Production System”, filed Apr. 11, 2011, which is hereby incorporated by reference in its entirety for all purposes.

### TECHNICAL FIELD

The present disclosure relates to a production system having at least one machine tool and at least one pallet handling system for the automatic loading of at least one machine tool with workpieces, wherein at least one pallet handling system has a storage unit which is associated with at least one machine tool and which includes one or more shelf modules.

### BACKGROUND AND SUMMARY

In automation engineering, pallet handling systems or pallet handling devices designate systems for dealing with material flow from or to a tool-center point. Means are in particular provided for the intermediate storage of the workpieces and handling devices are provided for the automatic loading of a machine tool with workpieces, which allows a machining process with low manning levels. Raw material and machined workpieces can be stored temporarily up to their manual removal; the loading of the machine tool takes place automatically according to a programmed control routine. The complete system of machine tool and pallet handling system is called a production system.

For the storage/stocking of the workpieces, corresponding storage units are set up in modular form of shelves each having one or more levels. Workpieces can be stored directly within the shelf modules or via pallets. The storage capacity decisively determines the time duration of the fully automated production cycle up to the next required manual intervention. The spatial extent of the storage unit is, however, limited by the working range of the technical means for loading the machine tool from the storage unit. An automatic access of the machine tool to all storage positions must always be ensured in the sense of full automation. The working range of these handling devices for the automatic equipping of the machine tool must therefore be taken into account in the dimensioning of the storage unit.

A plurality of work processing following one another are required as a rule up to the completion of the workpieces which make the use of a plurality of task-specific machine tools necessary. The degree of automation in this respect as rule extends to a machining process, that is to a specific machine tool having the corresponding associated storage unit. Overarching automation, that is the linking of the storage units or of the machine tools has previously been extremely complex and expensive.

The object of the present disclosure is now to provide a production system which overcomes the above-described disadvantages.

This object is satisfied by a production system in accordance with the present disclosure including at least one machine tool as well as at least one pallet handling system which serves the automatic loading of at least one machine tool with workpieces. At least one storage unit associated with the machine tool is provided for this purpose and includes one or more shelf modules. To increase the storage capacity, the storage unit additionally includes at least one rotatable storage tower.

The storage tower may include one or more circular levels which each offer one or more storage positions and which can be brought into the working region of the machine tool by rotation of the storage tower or of individual levels. It is also possible that the storage tower includes a turntable having at least two shelf modules arranged thereon, with at least one shelf module being able to be brought into the working region of the machine tool due to the rotational movement of the turntable about its axis of rotation. The integration of the storage tower allows a more effective utilization of the available space for setting up the storage unit. Despite the small surface requirement of the storage tower, the resulting storage volume can be considerably expanded.

A plurality of shelf modules of the storage unit and the at least one rotatable storage tower may be arranged in a round construction about the access region of the associated machine tool. The round construction optimizes the mean distance between the storage positions and the machine tool, with the available space for setting up the shelf modules and the storage towers being ideally utilized. Due to the inherent stiffness of the shelves, a plugging of the shelves at the floor side can be superfluous, and thus optionally omitted, due to the round construction.

At least one lift module is provided for access to the individual storage positions of the shelf modules/storage towers. The lift module may include access to all storage positions of the available storage unit and can pick up the stored workpieces for the subsequent loading of the machine tool. The lift module is advantageously arranged in or directly at the center of the circular arrangement with an arrangement of the storage unit in round construction.

An eccentric arrangement of the lift module is also provided in one embodiment. The lift module in particular includes a turntable on which a carrier frame is eccentrically arranged. The carrier frame includes a loading access for providing access to the storage unit or to the machine tool. Due to the eccentric arrangement of the lift module or of the carrier frame, the possible range of the lift module or the carrier frame is increased. The number of achievable storage positions is thus increased, whereby the possible storage capacity rises.

Provision can furthermore be made that the lift module or the carrier frame is made in a telescopic design. The design of the lift module or of the carrier frame as a telescopic module can in particular further increase the possible range. This is above all of advantage with a direct loading of machine tables of a machine tool by the lift module.

The production system furthermore includes at least one pallet handling system which includes at least one equipping module which allows the external system access to the production system or to the pallet handling system, for example for removal or supply of the pallets or of individual workpieces.

The integration in accordance with the present disclosure of at least one storage tower has a further advantageous aspect in addition to the expanded storage space volume. In a particularly advantageous embodiment of the present disclosure, the production system includes at least two pallet handling systems as well as at least two machine tools with which in each case at least one storage unit of a pallet handling system is associated. The storage units can expediently be set up in accordance with one of the above advantageous embodiments. It is now particularly advantageous if at least one storage tower is arranged such that the at least two storage units associated with the two machine tools are linked to one another. Due to the rotatable design of the storage tower or of the individual levels, one or more storage positions of the storage tower can selectively be assigned either to the first storage unit or to the second storage unit. For example, a storage position of the storage tower is occupied by a workpiece machined by the first machine tool. Due to the rotatable design of the storage tower, the workpiece moves into the region of the second storage unit so that access to the workpiece for loading the second machine tool is possible.

The arrangement in accordance with the present disclosure provides a comparatively uncomplicated possibility for linking two or more machining processes. At least two or more storage units or machine tools can be linked to one another by at least one storage tower. It is equally also possible to establish the corresponding links between two or more machine tools over more than one storage tower.

The individual storage units of the respective machine tool are advantageously each designed in round construction, with the point or points of intersection between the storage units lying in the common storage tower or towers.

The flexibility of the pallet handling system is increased by a modular construction of at least one storage unit. An extension of the individual modules of the storage unit toward the top and also to the side is furthermore possible in that either the number of storage levels of the shelf modules or storage towers used is at least partly increased or reduced or the storage unit is retrofitted with at least one or more shelf modules/storage towers. The number of shelf modules on the storage tower or on the turntable of the storage tower can also be adapted to the demands. Generally, however, at least two shelf modules are installed on the storage tower.

The production system in accordance with the present disclosure may be used for the automatic loading of a machine tool, of a processing center or of a gear cutting machine. In this respect, the individual workpiece storage positions of the shelf modules or of the storage tower can also be utilized without a pallet, thus e.g. for gear cutting machines with ring loaders.

The present disclosure is furthermore directed to a pallet handling system for use in the production system in accordance with the present disclosure in accordance with one of the above advantageous statements. The advantages and properties of the pallet handling system correspond to those of the above advantageous statements with respect to the production system in accordance with the present disclosure so that a repeat description will be dispensed with at this point.

The present disclosure further relates to the advantageous use of a rotatable storage tower for linking at least two or more pallet handling systems. Two or more machine tools or their storage unit should in particular be linked. Reference is made to the above statements with respect to the advantages and properties of the advantageous use of the storage tower.

Further advantages and details of the present disclosure result from the embodiments shown in the drawings.

### BRIEF DESCRIPTION OF THE FIGURES

FIG. 1 shows an overview of the components of the production system in accordance with the present disclosure.

FIG. 2 shows a first embodiment of the production system in accordance with the present disclosure.

FIG. 3 shows a second embodiment of the production system in accordance with the present disclosure. The figures are drawn approximately to scale, although other relative sizing of the various components may be used.

### DETAILED DESCRIPTION

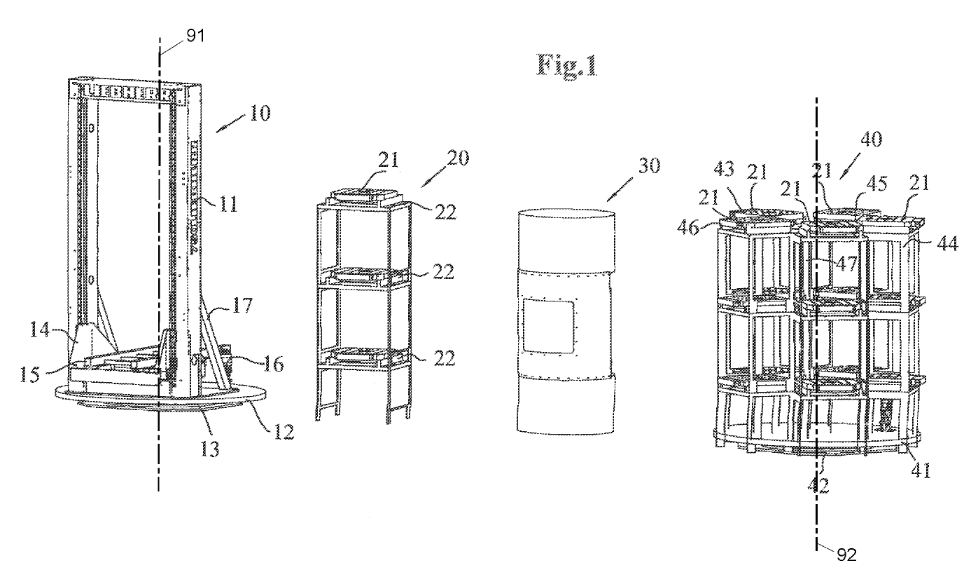

FIG. 1 provides an overview of the possible components of a pallet handling system of modular structure of the production system in accordance with the present disclosure. The Figure shows from left to right a lift module 10, a shelf module 20, an equipping module 30 and the storage tower 40. The lift module 10 includes a carrier frame 11 which is arranged fixedly on the turntable 12 and is rotatably supported relative to the base plate 13 via the turntable 12. In the embodiment shown, the carrier frame 11 is arranged eccentrically on the turntable 12 with respect to a central axis of rotation 91 of the turntable (located at a true center of the circular turntable 12), whereby the range of the lift module 10 or of the carrier frame is expanded.

For stabilization, the carrier frame 11 is supported with respect to the turntable 12 via the support elements 17. The rotational drive of the turntable 12 is designated by the reference numeral 16. The travel slide 14 is supported in a linearly displaceably manner in the vertical direction within the carrier frame 11. The travel slide 15 which is horizontally movable in both directions with respect to the slide 14 is additionally fastened to the travel slide 14. The corresponding storage level 22 of the shelf module 20 or of the storage tower 40 is accordingly moved to via the travel slide 14, with the travel slide 15 being moved to pick up the stored pallet or the workpiece.

Furthermore, a possible shelf module is shown with the reference symbol 20 which has three levels 22 for accepting a respective one storage pallet 21.

The storage tower 40 includes a turntable 41 which is rotatable about a vertically standing axis of rotation 92 with respect to the base plate 42. Five shelf modules 43, 44, 45, 46, 47 of the same type are taken up via the turntable 41 and each include three or more storage levels 22 for storing the pallets 21 or workpieces. The number of the shelf modules installed on the turntable 41 is generally not fixedly predefined. However, at least two shelf modules are provided to ensure the operability of the storage tower 40.

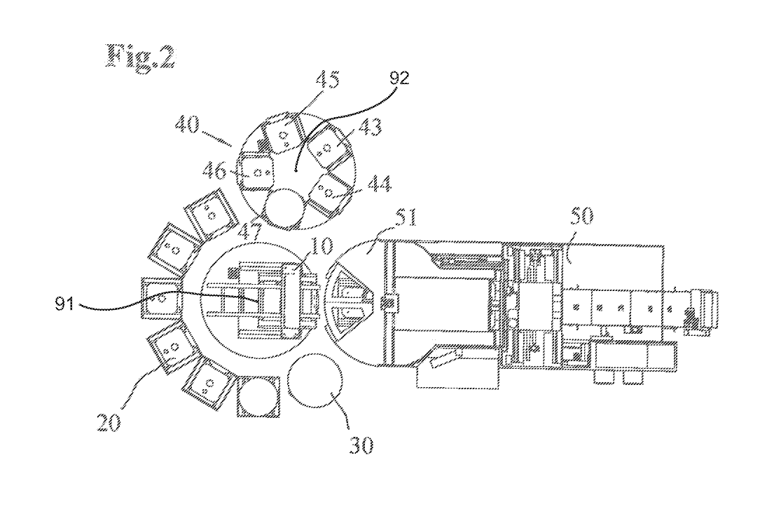

FIG. 2 shows a possible embodiment of the production system in accordance with the present disclosure having a pallet handling system for the automatic loading of the machine tool 50. The machine tool 50 can, for example, be designed as a gear cutting machine or as a processing center. The individual shelf modules 20 are arranged about the loading access 51 of the machine tool 50 in round construction. In one example, the loading access 51 is located at an end of the machine tool 50 and includes an opening positioned adjacent the lift module 10. The lift module 10, which has access to the storage levels of the shelf modules 20 with the aid of the travel slides 14, 15 described in FIG. 1, is located at the central mid-point of the shelf modules 20 arranged in round construction.

Furthermore, the equipping module 30 for the manual external access to the pallet handling system is positioned directly beside the machine tool 50.

The integration of the storage tower 40 in accordance with the present disclosure combines a high storage capacity with comparatively small space requirements. The turntable 41 of the storage tower 40 carries five shelf modules 43, 44, 45, 46, 47 whose individual levels are accessible via the lift module 10. In the example of FIG. 2, the pallets 21 or workpieces stored in the shelf module 47 can be removed via the lift module 10 and can be supplied directly to the machine tool 50 for loading it. All storage positions can be reached via a single lift module 10 by the rotatable design of the storage tower 40. The storage capacity can accordingly be increased without any modification of the lift module 10 used.

The modular structure of the storage unit made up of the shelf modules 20 and of the storage tower 40 does not only offer a simple expansion possibility of the storage volume, but likewise an increased flexibility of the system since the number of the shelf modules 20 and of the storage towers 40 can be adapted to the given demands without restriction. In addition, a subsequent expansion of the storage volume is conceivable both upwardly, that is by increasing the respective number of storage levels 22 per shelf module 20 or storage towers 40, and to the side by retrofitting the storage unit with one or more additional shelf modules 20 or storage towers 40.

The workpiece storage positions within the shelf modules 20 and in the storage tower 40 can also be utilized without a pallet 21 as required, which is expedient on the supply of a gear cutting machine by a ring loader. For this purpose, the lift module 10 is optionally given a gripper unit not shown in the Figures which allows a direct pick-up of a stored workpiece via the lift module 10.

The round construction of the shelf modules 20 and of the storage tower 40 can make the plugging of the shelves 20 in the floor superfluous since a certain inherent stiffness of the shelves 20 can be assumed.

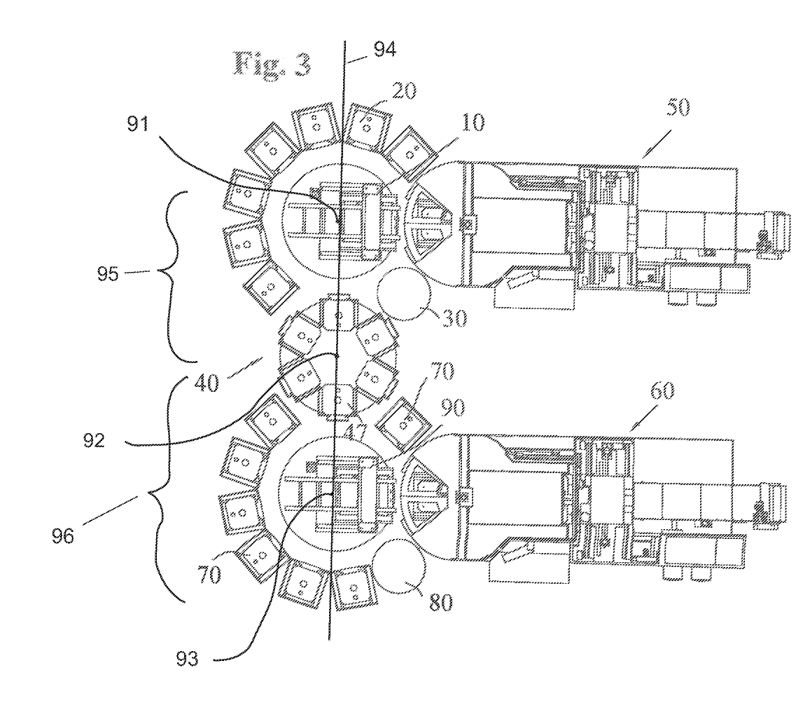

A possible embodiment of the production system having two machine tools 50, 60 and two pallet handling systems and comprising a cross-machine degree of automation can be seen from FIG. 3. A separate storage unit is associated with each machine tool 50, 60. The storage unit associated with the machine tool 50 includes seven shelf modules 20 arranged in round construction, an equipping module 30 as well as a lift module 10 disposed at the mid-point of the shelf arrangement. The storage unit which is associated with the machine tool 60 likewise includes seven shelf modules 70 arranged in circular form, an equipping module 80 as well as a lift module 90 standing at the mid-point. Lift module 90 includes a vertical axis 93, similar to axis 91. Further, as illustrated in FIG. 2, the axis of rotation of the lift modules and the storage tower are aligned with respect to one another along line 94, which is generally perpendicular to the parallel positioning of the machine tools. Of course, other arrangements are possible as additional machine tools and lift modules are integrated with a single storage tower. In each case, distance (95, 96) from each of the axes of the lift modules to an axis of the storage tower are equal.

The storage tower 40 rotatable in common which consequently forms the point of intersection of the two storage units is provided for linking the two storage units or machine tools 50, 60. The access to the storage tower 40 is permitted and possible via both lift modules 10, 90. A storage position of the shelf module 47 of the storage tower 40 can be reached via the lift module 90, for example. The rotational movement of the turntable 41 moves the shelf module 47 into the range of the storage unit associated with the machine tool 50. If necessary, the workpiece processed by the machine tool 60 in the shelf module 47 can then be removed by the lift module 10 and supplied to the machine tool 50.

Additionally or alternatively, the linking of two or more storage units can also take place with the aid of a lift and pivot unit or on the basis of a transport belt which are arranged between the storage units and allow the mutual exchange of pallets 21 or individual workpieces.

1. A production system comprising:
at least one machine tool; and
at least one pallet handling system for the automatic loading of the at least one machine tool with workpieces, wherein the at least one pallet handling system includes a storage unit which is associated with the at least one machine tool and which includes one or more shelf modules, wherein the storage unit additionally includes at least one rotatable storage tower.

2. The production system in accordance with claim 1, wherein a plurality of shelf modules of the storage unit are arranged in a round construction about an access region of the at least one machine tool.

3. The production system in accordance with claim 1, wherein the associated storage unit has at least one lift module for the equipping of the at least one machine tool with the workpieces stored within at least one shelf module/storage tower.

4. The production system in accordance with claim 3, wherein the lift module or the carrier frame of the lift module is arranged eccentrically to increase a range of the lift module/carrier frame.

5. The production system in accordance with claim 4, wherein the lift module or the carrier frame is made in telescopic design, wherein the range of the lift module/carrier frame is increased and/or the direct loading of the machine table of the machine tool is made possible.

6. The production system in accordance with claim 1, wherein the storage unit has at least one equipping module.

7. The production system in accordance with claim 1, wherein at least two machine tools are provided each having at least one pallet handling system, with at least one storage unit being associated with each machine tool and at least two of the associated storage units being linked via at least one storage tower rotatable in common.

8. The production system in accordance with claim 1, wherein at least two machine tools are provided each having at least one pallet handling system, with at least one storage unit being associated with each machine tool and at least two of the associated storage units being linked by at least one lift and pivot unit or at least one belt.

9. The production system in accordance with claim 7, wherein the storage units are each arranged in round construction in a region of their associated machine tool and two respective storage units are linked in round construction via a common storage tower.

10. The production system in accordance with claim 1, wherein at least one storage unit is of modular design and is upwardly and/or sideways expandable.

11. The production system in accordance with claim 1, wherein the at least one machine tool is a processing center or a gear cutting machine.

12. A production system comprising:
a first machine tool;
a first lift module arranged at an access end of the first machine tool, the first lift module including a first carrier frame which is arranged fixedly on a first turntable having a first vertical axis of rotation;
a second machine tool;
a second lift module arranged at an access end of the second machine tool, the second lift module including a second carrier frame which is arranged fixedly on a second turntable having a second vertical axis of rotation; and
a storage tower arranged between the first and second lift modules, the storage tower including a turntable which is rotatable about a vertically standing axis of rotation with respect to a base plate, a first and second vertical axes equidistant to the vertically standing axis.

13. The production system in accordance with claim 12, wherein a plurality of shelf modules of the storage tower are arranged in a round construction about an access region of the at least one machine tool.

14. The production system in accordance with claim 12, wherein each of the lift modules include an eccentrically arranged carrier frame.

15. The production system in accordance with claim 14, wherein the carrier frame is telescopic.

16. The production system in accordance with claim 15, wherein the storage tower has at least one equipping module.

17. The production system in accordance with claim 15, wherein the storage tower links the first and second machine tools so that components of the storage tower are available to each of the machine tool via their respective lift modules.

18. The production system in accordance with claim 15, wherein at least one storage tower is of modular design and is upwardly and/or sideways expandable.

19. The production system in accordance with claim 13, wherein the first machine tool is a processing center or a gear cutting machine.
